(19) United States
(12) Patent Application Publication
(10) Pub. No.: US 2025/0301003 A1
(43) Pub. Date: Sep. 25, 2025

(54) HARDWARE ANOMALY DETECTION WITH A CONFIDENCE BAND BASED ON MACHINE LEARNING IMPLEMENTING AN ISOLATION FOREST ALGORITHM

(71) Applicant: Acronis International GmbH, Schaffhausen (CH)

(72) Inventors: Dmitrii Mordovtsev, Sofia (BG); Serg Bell, Costa del Sol (SG); Stanislav Protasov, Singapore (SG)

(21) Appl. No.: 18/613,992

(22) Filed: Mar. 22, 2024

(51) Int. Cl. H04L 9/40

(52) U.S. Cl. CPC H04L 63/1425

(57) ABSTRACT

Systems and methods for anomaly detection are described and contemplated herein. An Isolation Forest algorithm is implemented for both training a plurality of machine learning models and accurately detecting multiple anomaly patterns in computer equipment time series data, such as CPU loads, temperatures, RAM usage, and other computer equipment metrics.

### TECHNICAL FIELD

Embodiments relate to the field of computer system anomaly detection. More particularly, embodiments relate to anomaly detection using machine learning implementing an Isolation Forest algorithm.

### BACKGROUND

Computer equipment stability and performance are governed by metrics like CPU loads, temperatures, and RAM usage. Monitoring these metrics is vital for early detection of potential malfunction. Traditional anomaly detection systems usually operate on singular thresholds, often missing intricate anomalies or giving false alarms. Moreover, many current clusterization-based algorithms are slow and inefficient for real-time monitoring and are not designed to identify multiple normal behavior and anomaly patterns.

Therefore, there is a need for systems and methods that can efficiently and accurately identify multiple anomaly patterns in time series data to ensure accurate and timely malfunction predictions.

### SUMMARY

Embodiments described or otherwise contemplated herein substantially meet the aforementioned needs of the industry. Embodiments described herein include systems and methods for anomaly detection using an Isolation Forest algorithm to quickly and accurately detect multiple anomaly patterns in computer equipment time series data, such as CPU loads, temperatures, RAM usage, etc. Unlike traditional methods with singular thresholds or slower clusterization techniques, embodiments provide timely and precise malfunction predictions by identifying intricate anomaly patterns in real-time.

In a feature and advantage of embodiments, use of an Isolation Forest Algorithm optimizes systems and methods for real-time monitoring to quickly detect anomalies as they emerge. In one example, embodiments are configured for high scalability and multi-processing. Moreover, the algorithms implemented ensure fast processing for large data volumes, suitable for real-time analysis. In another example, improved versatility is provided because embodiments do not presuppose any specific data distribution, enabling application across various datasets without the need for data to conform to specific distribution models. In another example, embodiments implement unsupervised learning to operate without labeled training data, facilitating easier deployment in scenarios where labeling is impractical. In another example, embodiments can adapt or be retrained with new data, making them effective in dynamically changing environments. Such attributes make embodiments uniquely efficient and adaptable for real-time anomaly detection across different data landscapes.

In a feature and advantage of embodiments, multiple anomaly patterns are evaluated. As a result, embodiments minimize false alarms and can identify malfunctions that are traditionally overlooked. In particular, because multiple separate normal behavior patterns can be determined, embodiments can easily detect complicated anomalies. Isolation Forest algorithms are specifically optimized for detecting multiple anomaly behavior patterns in time series data of computer equipment. As an example, consider a PC in which CPU utilization is 70% during working hours and 40% during night hours, thereby reflecting two patterns, which embodiments detect as normal, instead of making the average of those numbers (e.g. 55%) as normal.

In a feature and advantage of embodiments, adaptability is improved over traditional solutions. For example, because embodiments can be trained on specific equipment data, better-tailored malfunction predictions are provided.

In a feature and advantage of embodiments, efficiency is improved over traditional solutions. For example, embodiments bypass the limitations of singular threshold systems and outperform traditional slower anomaly detection techniques in timely malfunction detection. In particular, inference speed is improved, reduction in false positive rates is improved, a higher detection rate of true anomalies is achieved, and a marked decrease in the time required to identify and respond to anomalies is achieved. Such efficiencies are quantifiable in operational contexts, where the time to detect anomalies can be reduced by up to 50% compared to traditional threshold-based or slower anomaly detection techniques, thereby significantly enhancing the responsiveness and reliability of embodiments.

In an embodiment, a system for anomaly detection in a computer comprises a cloud-based metrics storage service configured to store a plurality of computer metrics received from a metrics reading library installed on the computer to monitor computer equipment, the plurality of computer metrics comprising a plurality of streams of data, each stream related to separate computer equipment; and at least one processor operably coupled to memory, and instructions that, when executed by the at least one processor, cause the at least one processor to implement: a training engine configured to train a plurality of computer equipment metric models using an Isolation Forest algorithm, wherein each of the plurality of computer equipment metric models is trained for a given metric using the stream of data for the given metric of the plurality of computer metrics, wherein each of the plurality of computer equipment metric models is associated with a different computer metric and not associated with any of the other plurality of computer equipment metric models, an inference engine configured to generate a prediction vector including a non-anomaly determination of 0 or an anomaly determination of 1 for each of the plurality of computer equipment metric models using an Isolation Forest algorithm, and a determination engine configured to evaluate the prediction vector to determine an anomaly pattern in the computer.

In an embodiment, a method of anomaly detection for a computer comprises storing a plurality of computer metrics received from a metrics reading library installed on the computer to monitor on-board computer equipment, the plurality of computer metrics comprising a plurality of streams of data, each stream related to separate on-board computer equipment; training a plurality of computer equipment metric models using an Isolation Forest algorithm, wherein each of the plurality of computer equipment metric models is trained for a given metric using the stream of data for the given metric of the plurality of computer metrics, wherein each of the plurality of computer equipment metric models is associated with a different computer metric and not associated with any of the other plurality of computer equipment metric models; generating a prediction vector including a non-anomaly determination of 0 or an anomaly determination of 1 for each of the plurality of computer equipment metric models using an Isolation Forest algorithm; and evaluating the prediction vector to determine an anomaly pattern cluster in the computer.

In an embodiment, a system for anomaly detection in a computer system comprises a processor and operably coupled memory, and instructions that, when executed by the processor, cause the processor to implement: a plurality of computer equipment metric models, each trained for a certain computer system metric by a training Extended Isolation Forest Algorithm using a stream of data for the certain computer system metric and not using any of the other metrics for the computer system, an inference engine configured to generate a prediction vector of at least one anomaly determination and at least one anomaly determination for computer system data for each of the plurality of computer equipment metric models according to an inference Extended Isolation Forest Algorithm, and a determination engine configured to present a graphical user interface of the prediction vector of a two-dimensional plot of time against each prediction vector against a confidence interval for each of the prediction vector values.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for anomaly detection, according to an embodiment.

FIG. 2 is a further block diagram of the system for anomaly detection of FIG. 1, according to an embodiment.

FIG. 3 is a further block diagram of the system for anomaly detection of FIGS. 1-2, according to an embodiment.

FIG. 4 is a block diagram of a prediction vector, according to an embodiment.

FIG. 5 is a flowchart of a method for anomaly detection, according to an embodiment.

FIGS. 6A-6B are diagrams of user interface (UI) dashboards including confidence level for anomaly detection, according to an embodiment.

FIG. 7 is a diagram of Isolation Forest confidence bounds including anomalies and scores, according to an embodiment.

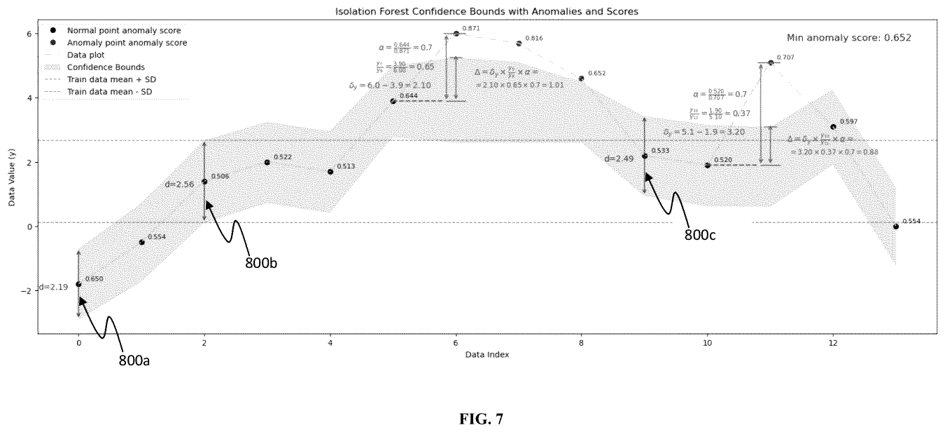

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Systems and methods for anomaly detection are described and contemplated herein. In embodiments, an Isolation Forest algorithm is implemented for both training a plurality of machine learning models and accurately detecting multiple anomaly patterns in computer equipment time series data, such as CPU loads, temperatures, RAM usage, and other computer equipment metrics. Extended Isolation Forest algorithms are specifically optimized for detecting multiple anomaly patterns in time series data of computer equipment.

In embodiments, a training process of the Isolation Forest algorithm involves constructing multiple isolation trees (iTrees) from random sub-samples of the data. Each iTree is built by recursively partitioning the data, selecting a feature and a split value at random until all points are isolated or a maximum tree depth is reached. Anomalies are identified based on the principle that they are easier to isolate and, therefore, will have shorter path lengths in the iTrees. The anomaly score is derived from the average path length across all trees in the forest, with shorter paths indicating a higher likelihood of being an anomaly. This ensemble method enables the Isolation Forest to efficiently and effectively detect outliers in large, high-dimensional datasets.

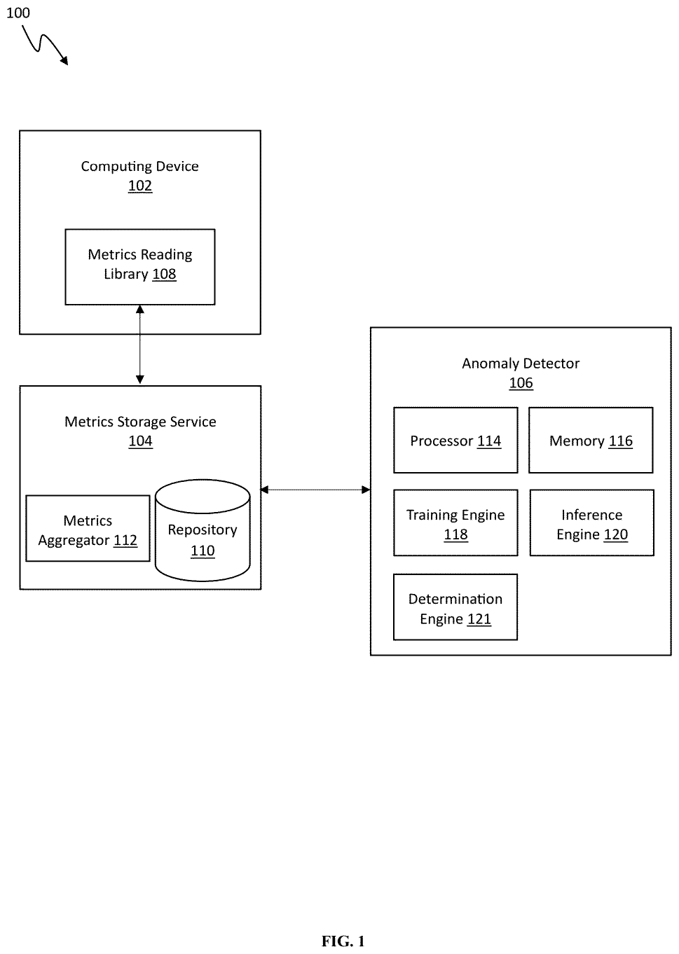

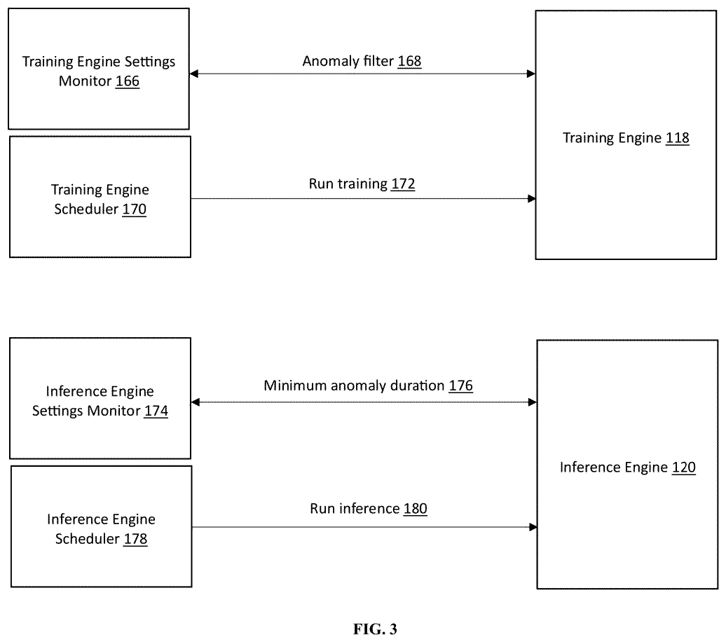

Referring to FIG. 1, a block diagram of a system 100 for anomaly detection is depicted, according to an embodiment. System 100 generally comprises a computing device 102, a metrics storage service 104, and an anomaly detector 106. In certain embodiments, system 100 further comprises a training engine settings monitor 166, a training engine scheduler 170, an inference engine settings monitor 174, and an inference engine scheduler 178, as will be described with respect to FIG. 3.

Embodiments described herein include various engines, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Computing device 102 comprises an electronic device protected by system 100. In an example, computing device 102 can be desktop computer, a laptop computer, tablet, mobile computing device, server, workstation, or Internet-of-things (IoT) device, among other electronic devices. Accordingly, computing device 102 comprises on-board computer equipment to store and execute instructions such as a CPU and memory such as RAM. In another example, computing device 102 comprises other on-board computer equipment, such as a chipset including buses and interconnects to allow the CPU, memory, and input/output devices to interact.

In an embodiment, computing device 102 comprises a metrics reading library 108. Metrics reading library 108 comprises one or more engines to collect data about on-board computer equipment. In embodiments, metrics reading library 108 can be installed onto hardware or firmware of computing device 102.

Metrics reading library 108 can further include additional monitoring functions configured to monitor activity of other components of computing device 102. For example, network adapter statistics, disk drives, input/output (I/O) operations and file system operations can be monitored, including files created, deleted, bytes read or written. In another embodiment, though not depicted in FIG. 1, system 100 can comprise additional metrics reading libraries configured to read data from other system devices, such as IoT devices. In embodiments, metrics reading libraries can read any measurable data of system 100.

For example, metrics reading library 108 can read or otherwise determine metrics for certain computer equipment. In an embodiment, metrics reading library 108 can read metrics for all computer equipment, such as for computing device 102, and/or other system 100 equipment. In another embodiment, metrics reading library 108 can read metrics for selected computer equipment. For example, system 100 can be configured such that of-interest computer equipment is monitored as less than all computer equipment.

In an embodiment, metrics reading library 108 can read metrics continuously or periodically. In some aspects, metrics reading library 108 can read at intervals of at least 10 seconds, in some aspects at least 30 seconds, in some aspects at least 1 minute, in some aspects at least 2 minutes, and in some aspects at least 5 minutes. When a given read frequency is shorter, hardware parameters are read more often and can cause additional load on a computing device. If a given frequency is too long, some anomaly spikes may be lost, because the metric will be averaged on this interval.

The reading interval is adjusted according to requirements for specific use cases. For most cases, 60 seconds is an optimal interval. However, if more precise data is needed to detect even short fluctuations, shorter intervals can be selected. For example, on server equipment with critical workloads, if spikes in CPU load are determined, even more precise intervals can be utilized compared to average ones for root cause localization.

Metrics reading library 108 can output one or more streams of data. For example, metrics reading library 108 can provide individual streams for each component of computer equipment. In one example, metrics reading library 108 can provide an individual stream of CPU temperature for each moment of time (e.g. reading interval). In another example, metrics reading library 108 can provide an individual stream of RAM percentage used for each moment of time (e.g. reading interval).

Metrics storage service 104 is a cloud-based service configured to store stream data related from metrics reading library 108. In an embodiment, metrics storage service 104 is communicatively coupled to other components of system 100 such that digital data is stored on servers in off-site locations. In an embodiment, metrics storage service 104 comprises one or more storage repositories 110, such as a database, logical disk space, file, or other suitable storage medium. In an embodiment, metrics storage service 104 further comprises a metrics aggregator 112. In an embodiment, metrics aggregator 112 is configured to receive one or more streams of data from metrics reading library 108 and interface to repository 110 to store data from the stream in repository 110.

In one embodiment, metrics aggregator 112 merely passes every data point in a stream to repository 110. In another embodiment, metrics aggregator 112 is configured to aggregate, summarize, normalize, or otherwise reduce the metrics in a stream. In embodiments, metrics aggregator 112 can reduce the data before storing to repository 110. In another embodiment, metrics aggregator 112 can reduce the data after storing to repository 110, such as by retrieving data from repository 110 then reducing the data for transmission (such as to training engine 118 or inference engine 120 as will be described).

In an embodiment, metrics aggregator 112 can compress and archive stream data. In one example, metrics aggregator 112 can send aggregated data for dashboards, where sending each data point might be redundant, aggregated data over a specific time interval is used instead.

In an embodiment, metrics are uploaded to metrics storage service 104 from metrics reading library 108 at a certain frequency. In some aspects, metrics are uploaded to metrics storage service 104 every hour, in some aspects every 4 hours, in some aspects every 12 hours, in some aspects every 24 hours, in some aspects every 36 hours, and in some aspects every 48 hours. A tradeoff exists between uploading metrics and incorporating the latest data. For example, if metrics are uploaded too often it will lead to excessive load on the server and network. Upload frequency can be adjusted depending on how often the hardware utilization profile of the equipment changes. For example, if it is assumed that the utilization of the CPU and RAM, for example, will always be between 40-60%, then the frequency can be reduced, because certain models for CPU and RAM do not need to be retrained as often, since the certain models for CPU and RAM will not incorporate any “new” data. In embodiments, upload frequency can be varied metric-by-metric. Further, upload frequency can be varied to increase the upload frequency or decrease the upload frequency based on real-time metrics. For example, if metrics aggregator 112 detects a change in one or more metrics, it can update the frequency (e.g. if the metric is currently outside of an expected range).

Anomaly detector 106 is configured to train a plurality of machine learning models and detect an anomaly using the models. In an embodiment, anomaly detector 106 generally comprises a processor 114, an operably coupled memory 116, a training engine 118, an inference engine 120, and a determination engine 121.

Training engine 118 is configured to train or retrain the plurality of machine learning models using an Extended Isolation Forest algorithm. For example, training engine 118 can include a library as a collection of resources to implement the training or retraining of machine learning models. In an embodiment, each model of the plurality of machine learning models is associated with only one computer-component metric.

Inference engine 120 is configured to detect an anomaly on computing device 102 using the plurality of machine learning models and an Isolation Forest algorithm to generate a prediction vector. For example, inference engine 120 can include a library as a collection of resources to implement prediction vector generation.

In an embodiment, an extended version of the Isolation Forest algorithm utilized respectively by training engine 118 and inference engine 120 which is tailored for outlier detection, with the capability to perform single-variable splits on numeric data. Outlier detection tailoring can include fine-tuning of the Isolation Forest algorithm to enhance sensitivity to anomalies by adjusting split criteria to efficiently isolate outliers, leveraging unique data characteristics that differentiate them from normal observations.

In an embodiment, the Isolation Forest algorithm incorporates automatic depth limitation. Automatic depth limitation includes implementation of a dynamic maximum tree depth to prevent overfitting and reduce computational complexity, ensuring balanced tree growth and maintaining optimal processing speed.

In an embodiment, the Isolation Forest algorithm incorporates a penalization mechanism. In an example, penalization is introduced for values outside a predetermined range, thereby prioritizing isolation of significant outliers to improve detection specificity.

In an embodiment, the Isolation Forest algorithm incorporates standardization of data at each node. Node-level data standardization standardizes data at each tree node, thereby normalizing splits across diverse data distributions, which increases the model's adaptability and consistency in isolating outliers.

Such improvements in extended Isolation Forest algorithms present a robust approach to outlier detection, offering significant improvements in detection accuracy, computational efficiency, and model adaptability compared to conventional methods. In an embodiment, by utilizing the same model for both training and inference, improvements are created over other traditional solutions. In an example, during the training process a model is received—a forest which is a set of tree structures (iTrees)—then this model is used for predictions. The forest obtained as a result of the training cannot be used with another algorithm, because the unique set of tree structures are computed specifically for use Isolation Forest algorithms, such as the Isolation Forest inference algorithm, and not for use in other inference algorithms. More particularly, in an example embodiment, an iTree is a binary tree specific to the Isolation Forest algorithm.

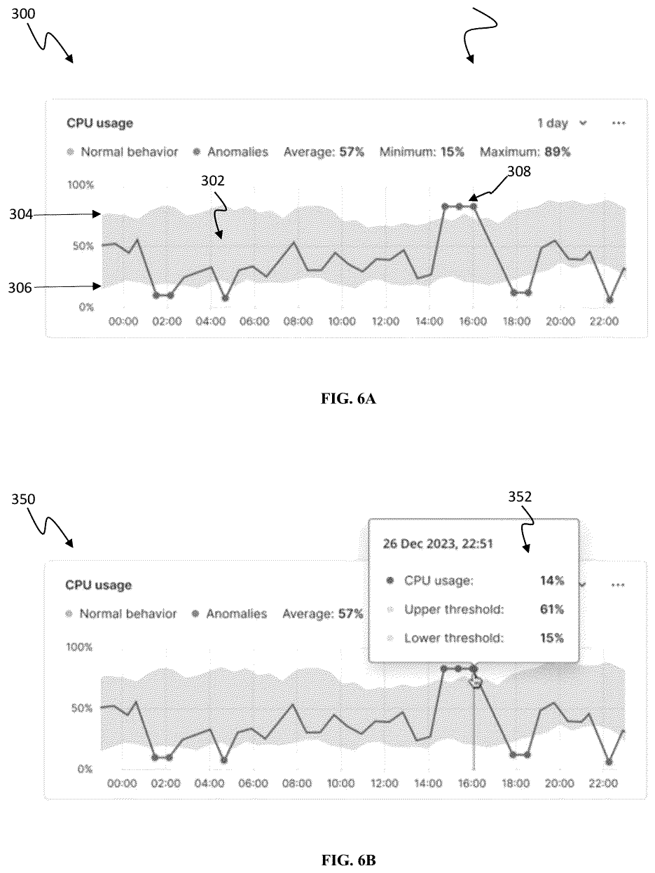

Determination engine 121 is configured to evaluate the prediction vector generated by inference engine 120 to determine an anomaly pattern. In an embodiment, determination engine 121 comprises a user interface (UI) sub-engine to evaluate the prediction vector and present a text-based or graphics-based evaluation of the prediction to a user. In an embodiment, determination engine 121 can evaluate the prediction vector to determine an anomaly pattern. For example, an anomaly pattern can be identified by the predictions of anomalies for those given metrics. Example UI dashboards are described further with respect to FIG. 6.

As described herein, the prediction vector includes {0} or other suitable binary value indicating a non-anomaly data point, and {1} or other suitable binary value indicating an anomaly data point. Accordingly, determination engine 121 can evaluate the relative values in the vector. In other embodiments, determination engine 121 can identify an anomaly pattern automatically as a continuous number of consecutive anomalies (1s) in a prediction vector (further defined as anomaly duration). In an embodiment, a user sets the parameter to the minimum count of anomalies t, for example when t=3. prediction vector [0,0,1,0,0,1,1,0] will not be considered as anomaly pattern, while [0,0,1,0,1,1,1,0] will be considered as anomaly because it has three consecutive anomalies (1s).

In an embodiment, the minimum count of anomalies can be associated with sensitivity and can be set by the user according to the equipment workload type. For example, for more or less constant workloads this parameter can be set less, e.g. 10 (the number is related to the amount of time intervals, if the metric reading interval is 1 minute, so 10 indicates consecutive anomalies during 10 mins). For the more random workloads like an office desktop, the minimum count of anomalies can be set as 15, 20, or 30 minutes depending on the user activity. Larger values of the minimum count of anomalies can reduce false positives but in turn some anomalies might be missed.

Anomaly detector 106 is operably coupled to computing device 102; for example, through metrics storage service 104 as depicted in FIG. 1. Though anomaly detector 106 and computing device 102 are depicted in FIG. 1 as separate components, anomaly detector 106 and its components or some of its components can be physically located on computing device 102. In other embodiments, anomaly detector 106 is communicatively coupled to computing device 102 such as over a network. For example, training engine 118 and inference engine 120 can be deployed on separate external machines, on the same external machine, or on a cluster of machines.

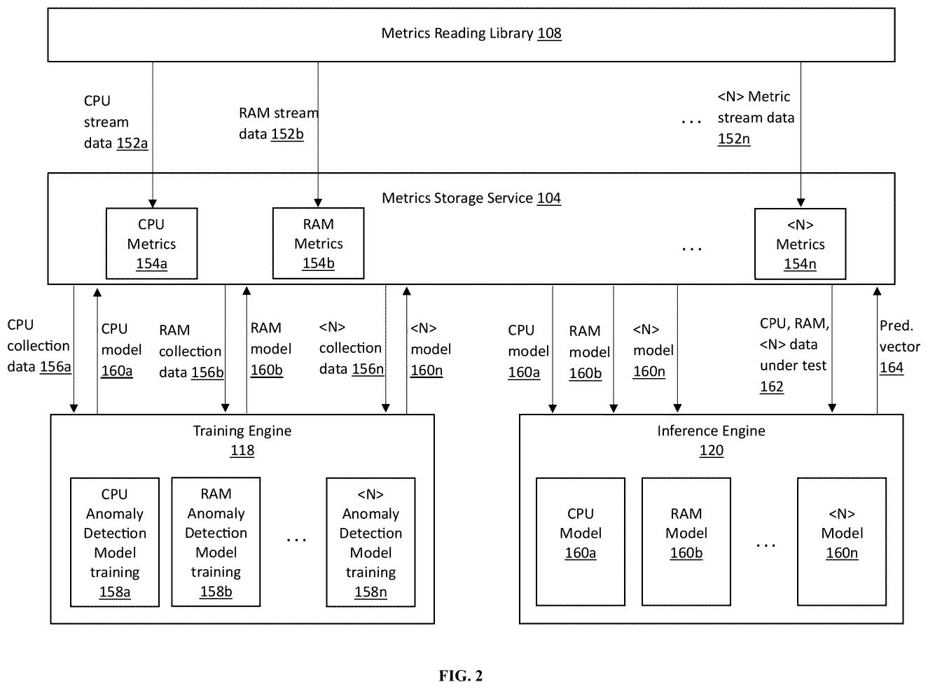

Referring further to FIG. 2, a further block diagram of system 100 is depicted, according to an embodiment. Specifically depicted are metrics storage service 104, metrics reading library 108, training engine 118, inference engine 120, and various exemplary communications respectively between these components.

Metrics reading library 108 can read or otherwise determine metrics for certain computer equipment and communicates the metrics to metrics storage service 104 in the form of data streams, such as over a network. As illustrated in FIG. 2, metrics reading library 108 can pass CPU stream data 152a, RAM stream data 152b, and other <N> metric stream data 152n to metrics storage service 104. For example, CPU stream data 152a can be associated with a CPU temperature of computing device 102. RAM stream data 152b can be associated with a RAM percentage used or RAM percentage available of computing device 102. In an embodiment, each data stream 152a, 152b, 152n is reflective of only one computer component metric.

In an embodiment, the format of a data stream is an array of values, such as integer or float values. For example, CPU stream data 152a can be an array of CPU usage percentage values [78, 5, 16, 7 . . . ]. In another example, RAM stream data 152b can be an array of memory usage percentage values [50, 31, 13, 12 . . . ]. In an embodiment, data streams can further include a relative time indication, such as in a two-dimensional array or time value corresponding to the array values.

Metrics storage service 104 receives each data stream 152a, 152b, 152n and optionally reduces the data, for example, by metrics aggregator 112. In an embodiment, the metrics received or otherwise reduced include CPU metrics 154a, RAM metrics 154b, and <N> metrics 154n. Metrics storage service 104 stores CPU metrics 154a, RAM metrics 154b, and <N> metrics 154n in repository 110.

As needed, metrics storage service 104 retrieves data from repository 110 and communicates the data as collection data to training engine 118, such as over a network. For example, metrics storage service 104 can pass CPU collection data 156a, RAM collection data 156b, and <N> collection data 156n. Collection data 156a-n can respectively be a collection of data for a given metric. In some aspects, collection data is daily metric data, in some aspects weekly metric data, in some aspects bi-monthly metric data, in some aspects monthly metric data, and in some aspects, quarterly metric data. In an embodiment, a given collection can be each individual data point collected over the given time period. In other embodiments, a given collection can be aggregated or otherwise reduced (for example, by metrics aggregator 112).

In an embodiment, a format of collection data includes a value and a corresponding measurement time stamp. In an aggregated collection, values over a corresponding time range can be provided. Aggregated values can be beneficial when it is desirable to see a larger snapshot, such as a monthly picture. In a monthly view, if measurements were taken (and transmitted) every minute (e.g. 43,200 data points), this can slow the subsequent data handlers, such as the UI and plot viewpoint.

Training engine 118 receives each data collection 156a, 156b, 156n and trains or retrains a plurality of models for anomaly detection using the respective data collections, such as in-training models CPU anomaly model 158a, RAM anomaly model 158b, and <N> anomaly model 158n.

For example, CPU metrics 154a corresponding to CPU temperature is used as training data to train CPU anomaly model 158a to determine an anomaly for CPU temperature. In another example, RAM collection data 156b corresponding to RAM percentage utilized is used as training data to train RAM anomaly model 158b to determine an anomaly for RAM percentage utilized.

More particularly, a model for a given computer equipment metric can be trained by first, calculation of mean and standard deviation for a basic anomaly filter, second, passing the array of data values (e.g. whole numbers as {1,2,-1,0,5,3} as input to an Isolation Forest training function, and third, writing the mean, standard deviation, and model (e.g. CPU model 160a, RAM model 160b, or <N> model 160n) to file.

Though only “CPU model 160a,” “RAM model 160b,” and “<N> model 160n” are depicted in FIG. 2 as communicated back to metrics storage service 104, respective mean and standard deviation values can likewise be communicated, such as individual parameters that are passed with the model or as a part of the model itself. In embodiments, training engine 118 can communicate to metrics storage service 104 an identifier of the respective computer device and an indication of the respective computer equipment type (with 160a-n). Metrics storage service 104 can accordingly store the models 160a-n in repository 110.

Training engine 118 intentionally keeps each in-training model 158a-n separate and disconnected from each other in-training model 158a-n. Likewise, training engine 118 intentionally keeps each trained model 160a-n separate and disconnected from each other trained model 160a-n. Separate and disconnected models allow for efficiency in training (e.g. only training on single metric type) and lowers system overhead (e.g. multiple simpler models can be less costly than a large, aggregated model).

Metrics storage service 104 can communicate the trained models 160a, 160b, 160n to inference engine 120, such as over a network. Metrics storage service 104 can further communicate data for inference such as CPU, RAM, <N> data 162 to inference engine 120. Data for inference can include computer equipment data at a given instance (e.g. current data, data for a given time period, etc.) to be used in anomaly detection by application to its respective model.

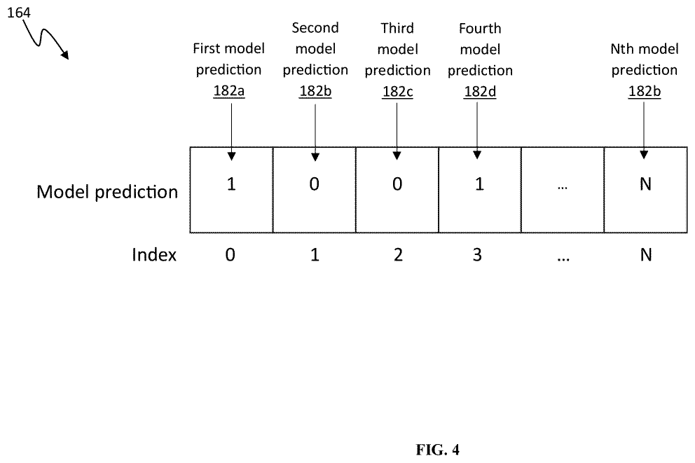

Inference engine 120 can utilize trained models 160a-n and apply data for inference such as CPU, RAM, <N> data 162 to each respective model. For example, current CPU data is applied to trained CPU model 160a, current RAM data is applied to trained RAM model 160b, and so on to current <N> data is applied to trained <N> model 160n. Accordingly, because inference engine 120 implements the trained models and not also the training functionality of training engine 118, inference engine 120 can be implemented on a relatively lightweight computing device. In an embodiment, a prediction vector 164 is generated, as will be further explained with respect to FIG. 4. In an embodiment, Isolation Forest inference function is called that applies the data for inference to its respective model using an Isolation Forest algorithm.

A plurality of streams 152a-n, a plurality of metrics 154a-n, a plurality of collection data 156a-n, a plurality of in-training models 158a-n, a plurality of trained models 160a-n, and a plurality of data for inference 162a-n indicates that each of these respective components are implemented for each metric of a plurality of metrics associated with the equipment of computing device 102 and optionally, other components of system 100.

Referring to FIG. 3, a further block diagram of system 100 is depicted, according to an embodiment. As mentioned, system 100 can further comprise training engine settings monitor 166, training engine scheduler 170, inference engine settings monitor 174, and inference engine scheduler 178.

Training engine settings monitor 166 comprises an engine configured to establish training settings for training engine 118, such as a basic anomaly filter 168. In an embodiment, training engine settings monitor 166 can itself derive basic anomaly filter 168 and pass basic anomaly filter 168 to training engine 118. In another embodiment, training engine settings monitor 166 can derive inputs for training engine 118 to derive basic anomaly filter 168. Accordingly, training engine settings monitor 166 is operably coupled to training engine 118.

In an embodiment, basic anomaly filter 168 comprises a function to remove false positive alerts. For example, training engine 118 and/or training engine settings monitor 166 can calculate the mean and standard deviation on a given set of training data. Anomalies are filtered if such anomalies got into the confidence interval between [MEAN+x*STD, MEAN−x*STD], where x is a configurable constant. In an embodiment, x is defined by a filter sensitivity, such as x=[1, 2, or 3], where 1 is low sensitivity, 2 is moderate sensitivity, and 3 is high sensitivity. Other filter sensitivities can likewise be incorporated, such as fractional values for more nuanced separation; for example x=[0.1, 0.2, 0.3]. Other filter sensitivities such as x=[0, 6] for greater separation can likewise be incorporated. In an embodiment, a maximum sensitivity of 6 can be used. In an example, [−1, 1] is associated with 68% of data, [−2, 2] is associated with 95% of data, and [−3, 3] is associated with 99.7% of data, according to a typical parabolic curve of sensitivity against total data volume. Basic anomaly filter 168 can accordingly be integrated into the training of in-training models 158a-n.

Training engine scheduler 170 comprises an engine configured to command training 172 of one or models trained by training engine 118. Accordingly, training engine scheduler 170 is operably coupled to training engine 118. In an embodiment, training engine scheduler 170 can run training 172 when a model has not yet been trained or when retraining should be conducted.

Inference engine settings monitor 174 comprises an engine configured to establish a minimum anomaly duration 176 for inference engine 120. Accordingly, inference engine settings monitor 174 is operably coupled to inference engine 120. In an embodiment, inference engine settings monitor 174 is configured to measure anomaly duration. In an embodiment, inference engine settings monitor 174 counts how many consecutive anomalies have occurred. If the consecutive anomalies are less than a configured value, then the data point is not treated as an anomaly (even though the algorithm indicates an anomaly). In a further example, some machines periodically experience a heavy workload which may lead to increased false positives. Accordingly, the configured value for consecutive anomaly evaluation can be increased, depending on expected heavy workload time.

Inference engine scheduler 178 comprises an engine configured to command an inference calculation by one or more trained models. In an embodiment, inference engine scheduler 178 can run an inference when one or more models are trained.

An output of inference engine 120 is prediction vector 164. Referring to FIG. 4, a block diagram of exemplary prediction vector 164 is depicted, according to an embodiment. As illustrated, prediction vector 164 comprises an array of individual model predictions [0 or 1] indexed according to [0, N]. In an example, an individual model prediction is [0] if the metric is not an anomaly or [1] if the metric is an anomaly, according to the specific model for the metric. The metric is one specific measurement collected in a time interval (e.g. CPU temperature in a specific date in a specific minute as CPU data for inference 162).

As illustrated, vector [0] indexes to first model prediction 182a (e.g. illustrated as “1”-anomaly). Vector [1] indexes to second model prediction 182b (e.g. illustrated as “0”-anomaly). Vector [2] indexes to third model prediction 182c (e.g. illustrated as “0”-no anomaly). Vector [3] indexes to fourth model prediction 182d (e.g. illustrated as “1”-anomaly). Vector [N] indexes to N model prediction 182n (e.g. illustrated as “N”).

In an embodiment, prediction vector 164 is depicted as a single-dimensional array of 0s or 1s. In another embodiment, prediction vector 164 can include a two-dimensional array of a prediction value [0,1] and a magnitude, such as value corresponding to a confidence level. In such an embodiment, a prediction value and magnitude can be utilized in an ultimate anomaly determination.

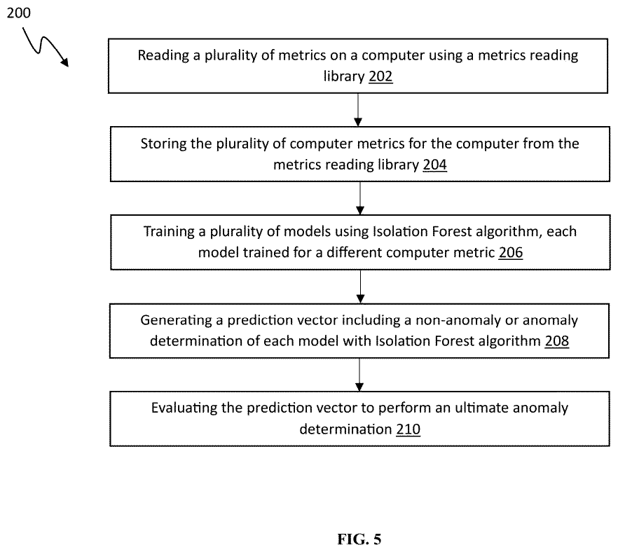

Referring to FIG. 5, a flowchart of a method 200 for anomaly detection is depicted, according to an embodiment. In an embodiment, method 200 can be implemented by system 100 as depicted in FIGS. 1-3 and including the vector in FIG. 4.

At 202, method 200 comprises reading a plurality of metrics on a computer using a metrics reading library. For example, metrics reading library 108 can read a plurality of metrics for computer equipment of computing device 102, or other computing equipment of system 100).

At 204, method 200 further comprises storing the plurality of metrics received from the metrics reading library. For example, metrics reading library 108 can communicate one or more streams of data reflecting the read metrics to metrics storage service 104. Metrics storage service 104 can store the metrics in repository 110, including storing of individual data points in the stream, or reduced values derived from the stream.

At 206, method 200 further comprises training a plurality of models using an Isolation Forest algorithm. For example, metrics storage service 104 can communicate one or more data collections 156a-n to training engine 118. Training engine 118 trains a plurality of models, one model trained for each different computer metric, using data collections 156a-n as training sets. In an embodiment, training engine settings monitor 166 integrates basic anomaly filter 168 into the training. In an embodiment, training engine scheduler 170 commands training of one or more of the plurality of models.

At 208, method 200 further comprises generating a prediction vector, the prediction vector including a non-anomaly or anomaly determination of each model using an Isolation Forest algorithm. For example, the trained models from training engine 118 can be sent to metrics storage service 104 for storage. Metrics storage service 104 can send the trained models 160a-n to inference engine 120. Further, metrics storage service 104 can send data for inference (e.g. CPU, RAM, <N> data 162) for application against its respective trained model 160a-n. Inference engine 120 then generates a prediction vector 164.

At 210, method 200 further comprises evaluating the prediction vector to perform an ultimate anomaly determination. In an example, a user can receive prediction vector 164 in text or graphical form by calling a web service or by using a UI dashboard via determination engine 121. In another example, determination engine 121 can evaluate the prediction vector to implement a remediation process on computing device 102.

Referring to FIGS. 6A-6B, diagrams of UI dashboards 300, 350 of confidence level for anomaly detection are depicted, according to an embodiment. To generate a given UI dashboard, embodiments can communicate a verdict for each data point (anomalous or not) and two values-upper and lower thresholds-to be used in a visual representation of how close a given point is to being an anomaly.

In an embodiment, a UI dashboard 300, 350 includes a 2D line plot depicting the historical values of the selected metric on a chosen interval. Referring to FIG. 6A, a confidence band 302 between an upper threshold 304 and a lower threshold 306 shows the expected normal behavior of selected metrics according to the learned pattern. Anomaly data points 308 are marked with a contrasting color and will reside outside the confidence band. Referring also to FIG. 6B, UI dashboard 350 can further comprise a detailed view 352 of a given anomaly data point.

Embodiments of a confidence bounds algorithm dynamically compute confidence bounds for anomaly detection, differentiating between anomalous and non-anomalous data points to adjust the intervals. For non-anomalous points, the confidence bounds are symmetrically set around the point, with the width determined by the deviation of a point's outlier score from the minimal score necessary to be considered an anomaly. This deviation influences the bounds, narrowing as the point's score approaches normalcy and widening as it approaches the anomaly threshold.

For anomalous points, the bounds are adjusted based on the relationship to the most recent non-anomalous point, using a coefficient derived from the anomaly score and the magnitude comparison between the current and previous points. This method smoothens the transition in confidence intervals, ensuring that the visual representation of the model's certainty in its predictions is both intuitive and reflective of the data's underlying dynamics.

The confidence bounding algorithm employs standard deviation and a calculated delta to dynamically adjust the bounds, providing a visual tool for identifying anomalies and understanding the model's confidence levels. By incorporating the context of previous data points, particularly in adjusting bounds for anomalous points, the algorithm offers a nuanced approach to visualizing and interpreting anomaly detection results, enhancing the clarity and utility of predictive modeling.

In an example of UI dashboard generation, an Isolation Forest classifier is trained on a data array T={0,1,1,0,2,3,4,2,1,0,0,1,1}.

A mean and standard deviation can be calculated or otherwise trained, such as mean(T)=1.23, SD(T)=1.19 and plotted.

A data array for inference I={−1.8, −0.5, 1.23, 2, 1.7, 3.9, 6, 5.7, 4.6, 2.2, 1.9, 5.1, 3.1, 0} is determined.

An Isolation forest output anomaly scores on inference data as Ai={0.65, 0.543, 0.467, 0.531, 0.506, 0.687, 0.871, 0.828, 0.699, 0.547, 0.525, 0.742, 0.626, 0.543}

Next, a predictions vector for inference data is determined Pi={0,0,0,0,0,1,1,1,0,0,1,0,0}, where 0=not anomaly, 1=anomaly.

A minimum anomaly score: 0.699, counted as minimum anomaly score in Ai, for the data points considered as anomalies.

In an embodiment, a calculation method for non-anomalous data points is described herein. For non-anomalous data points (those with an anomaly score below a min anomaly score), the calculation method applies a linear interpolation technique. Embodiments calculate a fraction that represents the position of the data point's anomaly score between the minimum score and the threshold. This fraction is then used to scale the standard deviation, effectively determining how much the confidence bounds should deviate from the actual data point value. By the band width (e.g. d values 800) growing while data values are closer to the training mean. More confidence about the non-anomality of the data is placed in this interval 800.

In an embodiment, a calculation method for anomalous data points is described herein. For anomalous points, the calculation method adjusts the approach to calculate the confidence bounds by considering the severity of the anomaly and its deviation from previously observed non-anomalous values.

A score coefficient calculation calculates a score coefficient based on the ratio of the minimum score threshold to the anomaly score of the data point. A fractional adjustment based on data values can evaluate the relationship between the current data point's value and the value of the previous non-anomalous data point to calculate a fraction according to Equation 1, which aims to quantify the relative deviation of the current data point from normalcy, adjusting for the magnitude and direction of the deviation.

$$\frac{{y}_{anomalous}^{not}}{{y}_{anomalous}} \qquad ( Equation 1 )$$

A distance calculation: δ_y is a distance between a current data point and a last non-anomalous point. Δ_y serves for adjusting the ratios to a data coordinate system.

A delta calculation is a distance between previous an anomalous point to interval bound. In an embodiment, a delta calculation is made according to Equation 2.

$$Δ = {Δ}_{y} \times \frac{{y}_{anomalous}^{not}}{{y}_{anomalous}} \times α \qquad ( Equation 2 )$$

Receiving upper and lower bounds is determined according to Equation 3.

$${y}_{b} = {y}_{anomalous}^{not} \pm Δ \qquad ( Equation 3 )$$

1. A system for anomaly detection in a computer, the system comprising:
a cloud-based metrics storage service configured to store a plurality of computer metrics received from a metrics reading library installed on the computer to monitor computer equipment, the plurality of computer metrics comprising a plurality of streams of data, each stream related to separate computer equipment; and
at least one processor operably coupled to memory, and instructions that, when executed by the at least one processor, cause the at least one processor to implement:
a training engine configured to train a plurality of computer equipment metric models using an Isolation Forest algorithm, wherein each of the plurality of computer equipment metric models is trained for a given metric using the stream of data for the given metric of the plurality of computer metrics, wherein each of the plurality of computer equipment metric models is associated with a different computer metric and not associated with any of the other plurality of computer equipment metric models,
an inference engine configured to generate a prediction vector including a non-anomaly determination of 0 or an anomaly determination of 1 for each of the plurality of computer equipment metric models using an Isolation Forest algorithm, and
a determination engine configured to evaluate the prediction vector to determine an anomaly pattern in the computer.

2. The system of claim 1, further comprising:
a training engine settings monitor configured to generate an anomaly filter based on a mean and a standard deviation for a given metric,
wherein the training engine is configured to train the model associated with the given metric using the anomaly filter to reduce false positives.

3. The system of claim 2, wherein the anomaly filter defines a confidence interval using the mean, the standard deviation, and a filter sensitivity.

4. The system of claim 3, wherein the filter sensitivity includes a low value, a medium value and a high value.

5. The system of claim 1, further comprising an inference engine settings monitor configured to increment a count of consecutive anomalies, and evaluate the count against a minimum anomaly value, wherein when the count is less than the minimum anomaly value, a non-anomaly determination is made for the given metric.

6. The system of claim 1, wherein the plurality of computer metrics includes processor load, processor temperature, and RAM usage.

7. The system of claim 1, wherein the determination engine is further configured to evaluate the prediction vector by presenting a graphical user interface of the prediction vector by a two-dimensional plot of time against each prediction vector value against a confidence interval for each of the prediction vector values.

8. The system of claim 7, wherein the confidence interval comprises a band having a lower bound and an upper bound, wherein the prediction vector value is positioned relative to the band such that anomaly predictions are outside the band and non-anomaly predictions are inside the band.

9. A method of anomaly detection for a computer, the method comprising:
storing a plurality of computer metrics received from a metrics reading library installed on the computer to monitor computer equipment, the plurality of computer metrics comprising a plurality of streams of data, each stream related to separate computer equipment;
training a plurality of computer equipment metric models using an Isolation Forest algorithm, wherein each of the plurality of computer equipment metric models is trained for a given metric using the stream of data for the given metric of the plurality of computer metrics, wherein each of the plurality of computer equipment metric models is associated with a different computer metric and not associated with any of the other plurality of computer equipment metric models;
generating a prediction vector including a non-anomaly determination of 0 or an anomaly determination of 1 for each of the plurality of computer equipment metric models using an Isolation Forest algorithm; and
evaluating the prediction vector to determine an anomaly pattern in the computer.

10. The method of claim 9, further comprising:
generating an anomaly filter based on a mean and a standard deviation for a given metric,
wherein the model associated with the given metric is trained using the anomaly filter to reduce false positives.

11. The method of claim 10, wherein the anomaly filter defines a confidence interval using the mean, the standard deviation, and a filter sensitivity.

12. The method of claim 11, wherein the filter sensitivity includes a low value, a medium value and a high value.

13. The method of claim 9, further comprising:
incrementing a count of consecutive anomalies; and
evaluating the count against a minimum anomaly value, wherein when the count is less than the minimum anomaly value, a non-anomaly determination is made for the given metric.

14. The method of claim 9, wherein the plurality of computer metrics includes processor load, processor temperature, and RAM usage.

15. The method of claim 9, wherein evaluating the prediction vector includes presenting a graphical user interface of the prediction vector by a two-dimensional plot of time against each prediction vector value against a confidence interval for each of the prediction vector values.

16. The method of claim 15, wherein the confidence interval comprises a band having a lower bound and an upper bound, wherein the prediction vector value is positioned relative to the band such that anomaly predictions are outside the band and non-anomaly predictions are inside the band.

17. A system for anomaly detection in a computer system, the system comprising:
a processor and operably coupled memory, and instructions that, when executed by the processor, cause the processor to implement:
a plurality of computer equipment metric models, each trained for a certain computer system metric by a training Extended Isolation Forest Algorithm using a stream of data for the certain computer system metric and not using any of the other metrics for the computer system,
an inference engine configured to generate a prediction vector of at least one anomaly determination and at least one anomaly determination for computer system data for each of the plurality of computer equipment metric models according to an inference Extended Isolation Forest Algorithm, and
a determination engine configured to present a graphical user interface of the prediction vector of a two-dimensional plot of time against each prediction vector against a confidence interval for each of the prediction vector values.

18. The system of clam 17, wherein the plurality of computer equipment metric models comprises:
a CPU load model trained to detect anomalies of CPU load on the computer system; and
a RAM load model trained to detect anomalies of RAM load on the computer system.

19. The system of claim 17, wherein the Extended Isolation Forest Algorithm implements outlier detection tailoring, automatic depth limitation, a penalization mechanism, and a node-level data standardization.

20. The system of claim 17, wherein the plurality of computer equipment metric models comprises a set of tree structures generated according to the training Extended Isolation Forest Algorithm, and wherein the inference engine is configured to analyze the set of tree structures using the inference Extended Isolation Forest Algorithm.
